(19) United States
(12) Patent Application Publication
(10) Pub. No.: US 2006/0183090 A1
(43) Pub. Date: Aug. 17, 2006

(54) System and method for computerized training of English with a predefined set of syllables

(76) Inventors: Theordore G. Nollan, Soledad, CA (US); Genaro T. Nollan, San Diego, CA (US)

Correspondence Address: KNOBBE MARTENS OLSON & BEAR LLP, 2040 MAIN STREET, FOURTEENTH FLOOR, IRVINE, CA, 92614, US

(21) Appl. No.: 11/059,297

(22) Filed: Feb. 15, 2005

(51) Int. Cl. G09B 17/00

(52) U.S. Cl. 434/178

(57) ABSTRACT

Systems and methods for computerized teaching of the English language are disclosed. The disclosed embodiments comprise presenting a predefined set of syllables representing the English language to a student visually and audibly such that the user learns to read and write each syllable. Furthermore, the student may be instructed to read and write words of the English language not included in the examples shown in front of each syllable utilizing their knowledge of the syllables.

### BACKGROUND OF THE INVENTION

1. Field of the Invention

The invention relates to a computerized device and method for teaching persons to read, write, and/or speak the English language. More particularly, the invention relates to systems and methods that use computer software to teach the English language using a defined set of syllables that are stored in memory and presented to a user via an output device.

2. Description of the Related Technology

Illiteracy remains problematic among both children and adults in the United States despite the existence and use of teaching aids in the art. A number of teaching methods include breaking the English language into phonic sounds and identifying or highlighting phonemes for a user. Many teaching aids include specific combinations of visual and audio output to a learning user with regard to phonemes or syllables of given text. While a number of devices and programs fulfill their particular objectives, few result in timely and effective learning of the first steps of reading and writing.

### SUMMARY OF CERTAIN INVENTIVE ASPECTS

One embodiment of a computerized system for teaching the English language using a predefined set of syllables comprises a peripheral interface for receiving input data entered by a user on one or more peripheral devices and transmitting output data to a user on the one or more peripheral devices, wherein the peripheral devices including a microphone. The computerized system further comprises a program nonvolatile memory for storing an input processing module for receiving and processing input data from the peripheral interface and converting audio data to digital data, a speech recognition module for receiving the digital data corresponding to audio data received by the microphone and determining speech components representing the audio data, wherein the speech components comprise letters, syllables and words of the English language, a syllable storage area for storing a defined set of syllables representing the English language, a student response processing module for assessing the student's learning based on responses entered by the student, a teaching processing module for determining the syllables to teach the student based on the assessment of the student's learning, a results processing module for evaluating the student's performance, and a speech synthesis module for converting digital data to audio data and transmitting the audio data to the peripheral interface. The computerized system also comprises a processor for executing the input processing module, the speech synthesis module, the teaching processing module, the student response processing module, the results processing module, and the output processing module.

In some embodiments, the defined set of syllables representing the English language comprises 230 syllables, and at least one of the syllables may be accompanied by at least three example words illustrating that the same syllable can be found at the beginning of a first word, in substantially the middle of a second word, and at the end of a third word.

The peripheral devices may further comprise an external network connection for communicating with a remote system via a network so that student responses and results are monitored on the remote systems. The peripheral devices may also further comprise at least one speaker for playing audio data generated by the output processing module to the user.

One embodiment of a computerized method of teaching the English language, wherein the method utilizes a defined set of syllables representing the English language, comprises vocalizing each letter of the English alphabet to a student, instructing the student to write each letter of the English alphabet so that the student learns to correctly write each letter, teaching a defined set of syllables to the student so that the student learns to correctly read and write each syllable, vocalizing the defined set of syllables to the student and instructing the student to write the syllables so that the student learns to correctly write each syllable, instructing the student to read and write words of the English language utilizing the student's knowledge of the syllables, and instructing the student of exceptions in the English language for which the words are spelled differently than their syllabic sound. The defined set of syllables representing the English language may comprise 230 syllables.

A computerized method of teaching the English language using a predefined set of syllables comprises presenting a defined set of syllables to a student so that the student learns to correctly read and write each syllable; and vocalizing and displaying the defined set of syllables to the student, wherein each syllable has a unique sound and spelling.

The computerized method may further comprise instructing the student to write the syllables so that the student learns to correctly write each syllable, instructing the student to read and write words of the English language utilizing the student's knowledge of the syllables, and/or instructing the student of exceptions in the English language for which the words are spelled differently than their syllabic sound.

Teaching the defined set of syllables may comprise heuristically presenting to the student a plurality of exemplary words for each of the syllables. Also, at least one of the exemplary words may be associated with the syllable being taught at the beginning of the word. At least one of the exemplary words may be associated with the syllable being taught in the middle of the word, and at least one of the exemplary words may be associated with the syllable being taught at the end of the word.

### BRIEF DESCRIPTION OF THE DRAWINGS

The above and other aspects, features and advantages of the invention will be better understood by referring to the following detailed description, which should be read in conjunction with the accompanying drawings. These drawings and the associated description are provided to illustrate certain embodiments of the invention, and not to limit the scope of the invention.

FIG. 1 is a flowchart illustrating an accelerated process of teaching a student to read and write English.

FIG. 2 is a flowchart illustrating a training process using an accelerated syllabic or usage training approach as performed on an English teaching system such as shown in FIG. 3 (see below).

FIG. 3 is a block diagram of a teaching system that utilizes the accelerated approach of teaching the English language as described herein.

FIG. 4 is a block diagram of a program ROM of the English teaching system shown in FIG. 3 having various processing modules.

### DETAILED DESCRIPTION OF CERTAIN EMBODIMENTS

The following detailed description of certain embodiments presents various descriptions of specific embodiments of the present invention. However, the present invention can be embodied in a multitude of different ways. In this description, reference is made to the drawings wherein like parts are designated with like numerals throughout.

In some embodiments, the student hears the vocalization of the phonetic sound of each letter of the English alphabet, accompanied with certain examples given after each letter. When the student is learning the phonetic sounds of each letter, it is advantageous to also teach the student to write the letters of the alphabet in printed form. In such embodiments, it can be beneficial to teach the student the printed form of the letter “a,” for example, instead of borrowing the manuscript form which the student will rarely find in the printed words when reading beginner's books. This is beneficial as there are more words that start with “a” than any other vowel. Once the student learns to read and write each letter of the English alphabet, the concept of syllables can be introduced to the student.

Syllables refer to the individual sounds that make up words. For example, syllables can be made of one or more letters such as “a” (one letter) plus “ble” (three letters) to make up the word “able.” In other examples, the same syllable can be found in the beginning, in the middle, or at the end of different words. In one such example, the syllable “fa” in the word “fan” is at the beginning of the word. The same syllable “fa” can be in the middle and/or at the end of a word, as in the word “alfalfa.” “Fa” can also be found only at the end of a word, as in the word “sofa.” In the same way that the sounds of letters make up the sounds of syllables, syllables are the sounds or building blocks that make up the words in many languages.

In addition, the same syllable can have a different sound in different words, for example, the digraph “bi” in “big” has a different sound than the digraph “bi” in “bike.” Similarly, the digraph “che” in “chest” has a different sound than the digraph “che” in the word “ache.”

Writing of words is usually done with small (lower case) letters. Big letters (upper case or capital letters) are most often used at the beginning of a sentence, or in the first letter of a proper name such as “David.” A sentence is a complete thought such as “I have many toys.” An incomplete thought, such as “many toys,” is called a phrase. When one begins to write, the student is taught to try to write complete thoughts and end the sentences with a small dot called a period.

Some uncommon words such as “uxor,” “epiphyte,” “xanthous” and a few others that were used in the positioning of some syllables are used to instill in the student, right from the start, that the use of the English dictionary is very beneficial. It is left to the discretion of the teacher, tutor or parent to subsequently teach the student that the meaning of unfamiliar words can be understood by reading within the text of the sentence.

In certain embodiments, the teacher strongly recommends that the student sound a syllable, or syllables, and asks the student to write the syllable(s) correctly instead of requesting the spelling of words. Once the student has been taught the various syllabic entries and is then familiar with the spelling of all or most of them, the student can be tested to write any word of the English language. The student can simply write phonetically by using the phonetic resources of this simplified syllabic approach, and the student can write just about any word very soon with very few spelling errors, which is very good progress for a beginner student. The same memory recall of the syllables described herein can be applied to reading. The person monitoring the student's reading can make corrections of mispronounced words, as opposed to reading the text before the student tries to read for him or herself. In this manner, the student often discovers that it is possible to begin to read without any help by recalling all or most of the syllables presented in this approach.

The approach as described herein includes accelerating the first learning steps of reading and writing. Notwithstanding the simplification of this approach over traditional methods, the dedicated student having the proper instructions, as described herein, can learn the first steps of reading and writing much faster than students learning to read and write by traditional rote methods. The student can also learn the first steps of writing much faster and with fewer spelling errors by simply recalling all or most of the syllables of the accelerated approach, as the student relies less on memorizing the spelling of every letter in the words being taught.

Listed below are the letters of the English alphabet, followed by the sound of each of the letters:
Aa Bb Cc Dd Ee Ff Gg Hh Ii Jj Kk Ll Mm Nn Oo Pp Qq Rr Ss Tt Uu Vv Ww Xx Yy Zz
ea ee eo oo
a sounds a like map, ó like ball, saw, or \overline{a} like day.
b sounds b like baby.
c sounds c like cat, or s like cell.
d sounds d like dad.
e sounds e like bed, \overline{e} like even or \overline{i} like eye.
f sounds f like face.
g sounds g like go or gh like page.
h sounds h like hand.
i sounds i like if, or \overline{i} like ice.
j sounds j like job.
k sounds k like kid.
l sounds l like lake.
m sounds m like mother.
n sounds n like no.
o sounds o like boy, \overline{o} like no, or ä like box.
p sounds p like pet.
q sounds q like quick.
r sounds r like rain.
s sounds s like sand, or sh like sugar or ship.
t sounds t like ten.
u sounds ú like pull, ü like union, or á like under.
w sounds w like water
x sounds cs like box, x ray.
y sounds y like yard or you.
z sounds z like zero or zoo.
ea usually sounds e like easy except in words like ocean or crustacean.
ee sounds e like bee, keep or see.
eo sounds e like in the word people.
oo usually sounds u like in book except in the words blood, door, flood or floor.

The prosodic sound of each letter listed above is like the code of the alphabet that is used to combine the letters or utter the sound of just one letter to form syllables. For example, “a” (one letter) plus “sy” (two letters) plus “lum” (three letters) forms the word “asylum.” When a student is being taught for the very first time the letters of the alphabet, it is easier for a young child to process one single sound or meaning for each letter than two sounds for the same letter. For this reason, when teaching using this approach, it is beneficial to teach the student just the individual prosodic sounds of each letter as opposed to combining the prosodic sounds with the names of the letters of the alphabet, such as “a”, “bee” for the letter “b,” “cee” for the letter “c,” “dee” for the letter “d,” and so forth. The prosodic sounds of each individual letter of the alphabet listed above matches directly with single or combined phonetic sounds that form the syllables. For example, the sounds of the letters “ddd” for “d,” plus “a,” plus “ddd” for “d” again, form the sound for the word “dad.” However, using the sounds of the names of the same letters, the student would tend to form the word “dad” as “dee” for “d,” plus “a,” plus “dee” for “d” to form the incorrect word “dee-a-dee.” The student has to make such silent mental corrections to overcome these incoherencies. To facilitate these mental corrections, the student is not generally taught the well known ABCs jingle until after mastering the accelerated learning approach.

The various syllables that are defined in the accelerated approach are listed below, followed by examples showing each syllable used in several different words. As shown in the list below, the same syllable can appear at the beginning of some words, in the middle of some words, and at the end of some words while usually having substantially the same sound:

| | |
|---|---|
| an and sand fan | ba bath abate samba |
| en end bend ten | be bed obey be |
| in ink pink fin | bi big cubic bambi |
| on only bone son | bo boy cowboy rainbow |
| un under hungry bun | bu bull fabulous buy |
| ar arm farm car | tha that lethargy Gotham |
| er erase fern over | the the other bathe |
| ir Iraq circus fir | thi this nothing ethic |
| or orage corner color | tho those method python |
| ur urge curve fur | thu thunder enthusiasm thus |
| da dad today panda | na nap banana iguana |
| de desk blender pride | ne nest honest one |
| di dig radio Lodi | ni nick animal zucchini |
| do dog adobe judo | no noise snow piano |
| du duck endure kudu | nu nucleus January menu |
| ma map armadillo coma | la lamp island koala |
| me men camel home | le leg calendar handle |
| mi milk smile salami | li lip pelican slit |
| mo Monday lemon Eskimo | lo log melon polo |
| mu muumuu lemur emu | lu lure elude lung |
| pa panda leopard opal | gla glass England glad |
| pe pet carpet cape | gle glen piglet ogle |
| pi picnic spider okapi | gli glimpse English glim |
| po pony hippopotamus tempo | glo glove aglow Anglo |
| pu puma republic octopus | glu glue englut glut |
| fla flag inflate flat | cra crayon scratch crab |
| fle flesh muffler waffle | cre crest concrete lucre |
| fli flick conflict inflict | cri cricket script crib |
| flo floor sunflower afloat | cro cross macro micro |
| flu flute influx reflux | cru cruise recruit scrub |
| bra branch library zebra | pra practice spray copra |
| bre bread sombrero hombre | pre press comprehend osprey |
| bri brick fabric bright | pri principal apricot April |
| bro brother abroad fibro | pro progress improve apron |
| bru brush February brunch | pru prune imprudent prude |
| gra grass program pellagra | ha hat behave aloha |
| gre great egret ogre | he hen behemoth cache |
| gri grill pilgrim grid | hi hill behind mahimahi |
| gro grow aground allegro | ho horse cohort Idaho |
| gru gruesome congruent grub | hu hug inhuman Oahu |
| wra wrap | sa sac dinosaur visa |
| wre wrench | se seven present house |
| wri wrist | si sit inside pachisi |
| wro wrong | so soft season also |
| wru wrung | su super usual pursue |
| kna knack | phra phrase diaphragm rephrase |
| kne knead | phre phrenetic phrenic |
| kni knit knife knight | phro nephron Aphrodite nephro |
| kno knock knot know | cial facial social special |
| knu knuckle | sion permission session vision |
| qua quality square aqua | sure assure leisure measure |
| que question request torque | ax ax taxes fax |
| qui quick squirrel squid | ex exit next flex |
| quo quotient sequoia quote | ix ixtle mixer mix |
| va van oval ova | ox oxen boxer sox |
| ve vegetable seven five | ux uxor exult tux |
| vi village divide anvil | xa xanthous Texas exam |
| vo volcano avocado salvo | xe xenon boxer oxen |
| za zap lizard pizza | xi Ximenes exit taxi |
| ze zebra dozen prize | ka kayak peekaboo polka |
| zi zipper quizzical Brazil | ke kettle market cake |
| zo zone ozone kazoo | ki kit pumkin ski |
| zu zucchini mazurka lazuli | ko koala Dakota gecko |
| ca cat pelican Inca | ku kudo ukulele skunk |
| ce center ocelot dance | ja jaguar ajar ninja |
| ci city special deci | je jelly project eject |
| co corn bacon taco | ji jig jujitsu kanji |
| cu cup circular focus | jo joy enjoy banjo |
| ga garden sugar toga | ju July injury jump |
| ge get tiger age | pha pharmacy alphabet elephant |
| gi give forgive magic | phe pheasant hyphen gopher |
| go gold begonia flamingo | phi Philadelphia amphibian |
| gu gum jaguar August | dolphin |
| fa fan alfalfa sofa | pho photo telephone amphora |
| fe fern safety safe | phy physics epiphyte trophy |
| fi fig goldfish fix | cla class declare clam |
| fo fork before fog | cle clerk inclement circle |
| fu full refuge tofu | cli click recline clip |
| bla blast ablaze semblance | clo cloth cyclone clot |
| ble blend emblem table | clu clue include club |
| bli blink blister oblige | ra rabbit orange camera |
| blo block oblong pueblo | re red forest tire |
| blu blue ablush blunt | ri rib caribou crib |
| pla plant eggplant display | ro rope brown taro |
| ple plenty complete apple | ru rule truth guru |
| pli plink compliment accomplish | fra frank refrain infra |
| plo ploy employee deploy | fre fresh refresh fret |
| plu Pluto surplus plum | fri frigid Africa friend |
| dra dragon hydrant tundra | fro frog defrost Afro |
| dre dress address cadre | fru fruit breadfruit frugal |
| dri drink mandrill tendril | thra thrash anthrax |
| dro drone android andro | thre threat thread three |
| dru drupe quadruped quadru | thri thrift thrill thrive |
| tra trap central contra | thro throat anthropoid through |
| tre trend strength centre | throw |
| tri trip citric electric | thru thrust thruway |
| tro tropical strong nitro | wha what whale wharf |
| tru true citrus untrue | whe when where wheat wheel |
| sha shark reshape ricksha | whi which whistle white |
| she shell cashew she | who who whole whopper |
| shi ship cushion sushi | wa water Hawaii Ottawa |
| sho short ashore show | we wet twelve owe |
| shu shuffle reshuffle shut | wi wind swim kiwi |
| ta tap potato manta | wo work sword two |
| te ten enter minute | wu wunderkind swum swung |
| ti ticket mantis coati | cha chat mechanic concha |
| to toy tortoise pinto | che chest hatchet ache |
| tu turtle lettuce tutu | chi chicken machine chichi |
| ya yard loyal Maya | cho chocolate anchovy nacho |
| ye yellow player rye | chem chemical chemistry sachem |
| yi yield playing saying | chlo chlorophyll schlock |
| yo yolk coyote yoyo | chu chunk Machu Picchu |
| yu yule cayuse Soyuz | chri Christmas |
| tude altitude atitude longitude | chro chrome achromatic schrod |
| tion action nation motion | |
| tive active attentive receptive | |
| ture lecture nature structure | |
| tial essential initial partial | |

Once the student becomes familiar with the generic syllables or word particles, the teacher soon recognizes that students begin to read faster than students learning to read by rote methods. The advantages of the accelerated approach are apparent when the student finds that he or she can begin to write by simply recalling the syllables listed above. Students from other countries learning English as a second language using the accelerated approach can also more rapidly learn the reading and writing of long technical or scientific words by simply recalling the syllables listed herein with few or no spelling errors. For example, a student can read and write the word “neuropharmacological” from the syllables “ne u ro pha r ma co lo gi ca l,” or alternatively from the syllables “neu ro phar ma co log i cal.”

When the student is familiar with all or most of the syllables, the teacher can ask the student to write words that are not in the list above simply by sounding the syllables and the sounds of letters of the chosen word. As an example, the student can be asked to write the word “dependable” in the following way: “de pe nnn da ble,” showing the separation of its syllables, “de pend a ble,” forming the word “dependable.” The teacher can explain to the student that the “i” sound at the end of most words becomes “y,” except, for example, in the Latin plural of nouns, which can be taught at a later time, and other adopted foreign words. An example of the “i” sound at the end of a word is the word “fancy.” Using the syllables listed above, the spelling of the word “fancy” would be “fa n ci,” while the actual spelling of the word would be “fan cy” with the ending of the word with an orthographic “y” instead of the phonetic “i.” The student is preferably instructed that when the vowel “e” appears at the end of most words the “e” has no sound except when the “e” appears at the end of adopted French words, such as entreé, flambé, sauté, etc. When teaching with the accelerated approached as described herein, it can be advantageous not to ask the student to spell words, but to instead urge the student to write by the sound of the syllables of the words that the student may want to write plus the sounds of the letters that may be between the syllables of the chosen words.

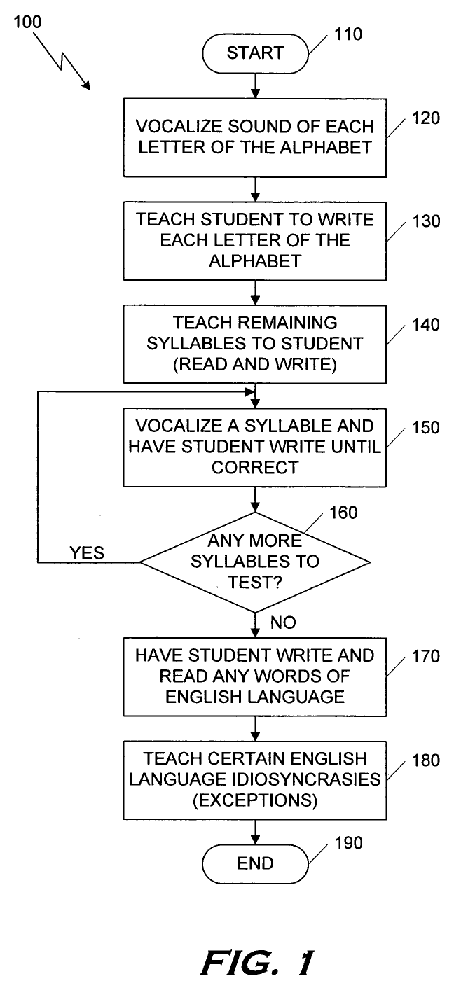

Referring now to the figures, FIG. 1 is a flowchart illustrating an accelerated process 100 of teaching a student to read and write English. The accelerated process 100 begins at a start block 110. At a block 120, the accelerated process 100 vocalizes the sound of each letter of the alphabet. The accelerated process 100 continues to a block 130 to teach the student to write each letter of the alphabet. At a block 140, the accelerated process 100 teaches the remaining syllables to the student, both for reading and writing purposes. The accelerated process 100 continues to a block 150 for vocalizing a certain syllable and having the student write the syllable until it is written correctly.

At a decision block 160, the accelerated process 100 determines whether there any more syllables on which to test the student. If it is determined at the decision block 160 that there are more syllables to test, the accelerated process 100 continues back to the block 150 as described above. However, if it is determined at the decision block 160 that there are not any more syllables to test, the accelerated process 100 continues to a block 170 to have the student write and read words of the English language. The accelerated process 100 continues to a block 180 for teaching certain English language idiosyncrasies or exceptions. The accelerated process 100 terminates at an end block 190.

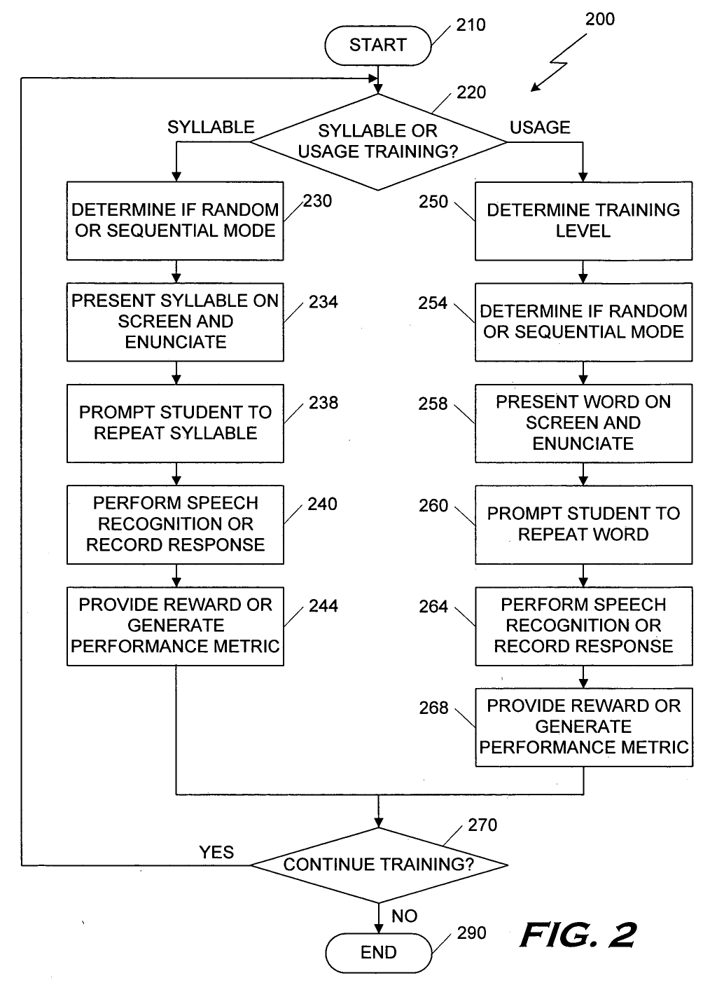

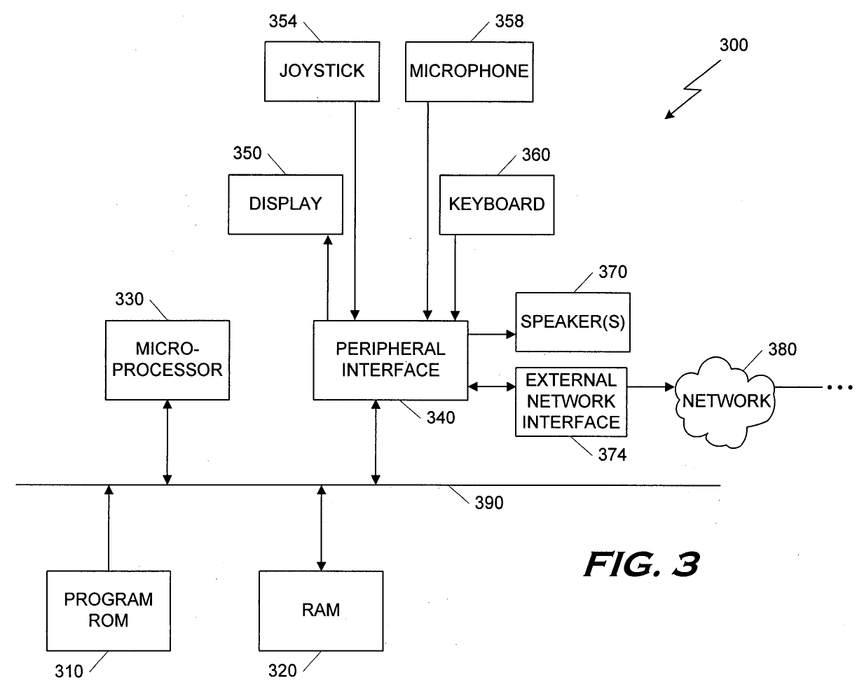

FIG. 2 is a flowchart illustrating a training process 200 using an accelerated syllabic or usage training approach as performed on an English teaching system such as shown in FIG. 3 (see below). The training process 200 begins at a start block 210. At a decision block 220, the training process 200 determines whether syllable training or usage training is performed. If it is determined at the decision block 220 that syllable training is to be used, the training process 200 continues to a block 230 to determine if random or sequential mode training is utilized. The training process 200 continues to a block 234 to present a syllable on the screen of the English teaching system and enunciate the pronunciation of the syllable. At a block 238, the training process 200 prompts the student to repeat the syllable as enunciated in the block 234. The training process 200 continues to a block 240 to perform speech recognition or record the response to the prompt of the block 238. At a block 244, the training process 200 provides a reward to the student for correctly pronouncing the syllable, or alternatively generates a performance metric, such as the number of syllables that the student correctly pronounced in proportion to the total syllables taught to the student.

However, if it is determined at the decision block 220 that usage training is to be used, the training process 200 continues to a block 250 to determine the training level of the usage training. For example, levels such as beginner, intermediate or advanced levels can be implemented. At a block 254, the training process 200 determines if random or sequential usage training is performed. The training process 200 continues to a block 258 to present the word to be taught on the screen of the English teaching system and enunciate the word to the student. The training process 200 continues to a block 260 to prompt the student to repeat the word that was presented and enunciated in the block 258. At a block 264, the training process 200 performs speech recognition or records the response provided by the student in response to the prompt given in the block 260. The training process 200 continues to a block 268 to provide a reward to the student for correctly pronouncing the word, or alternatively generate a performance metric, such as the number of syllables that the student correctly pronounced in proportion to the total syllables taught to the student.

After the block 244 or after the block 268, the training process 200 continues to a decision block 270 to determine whether to continue the training. If it is determined at the decision block 270 to continue the training, the training process 200 continues back to the decision block 220 as described above. However, if it is determined at the decision block 270 not to continue the training, the training process 200 terminates at an end block 290.

FIG. 3 is a block diagram of a teaching system 300 that utilizes the accelerated approach of teaching the English language as described herein. The embodiment of the teaching system 300 shown in FIG. 3 includes a program read-only memory (ROM) 310 for storing instructions that perform the operations as described for the training process 200 of FIG. 2. ROM refers to computer memory on which data has been prerecorded. Once data has been written onto a ROM chip, it can only be read and cannot be written. Unlike main memory, referred to as random access memory (RAM), ROM retains its contents even when the computer is turned off. Thus, ROM is referred to as being nonvolatile memory, whereas RAM is volatile memory. Other embodiments can include a variation of a ROM that is referred to as a programmable read-only memory (PROM). PROMs are manufactured as blank chips on which data can be written with a special device called a PROM programmer. In further embodiments, other memory devices such as flash memory, erasable programmable read-only memory (EPROM), electrically erasable programmable read-only memory (EEPROM), and the like, can be utilized.

The teaching system 300 shown in FIG. 3 includes a random access memory (RAM) 320 for storing dynamic data. As RAM is volatile memory, the data stored on the RAM 320 is not retained when power is removed from the teaching system 300. The teaching system 300 further comprises a microprocessor 330 configured to execute programs and modules stored at the program ROM 310 in conjunction with the RAM 320. The microprocessor 330 may be any conventional general purpose single- or multi-chip microprocessor such as a Pentium® processor, a Pentium® Pro processor, a 8051 processor, a MIPS® processor, a Power PC® processor, or an ALPHA® processor. In addition, the microprocessor may be any conventional special purpose microprocessor such as a digital signal processor or a graphics processor. The microprocessor typically has conventional address lines, conventional data lines, and one or more conventional control lines.

The teaching system 300 further comprises a peripheral interface 340 configured to communicate with a plurality of peripheral devices so as to receive in put data entered by a user on one or more peripheral devices and to transmit output data to the user on one or more peripheral devices. The plurality of peripheral devices may include a display 350, a joystick 354, a microphone 358 configured to receive audio input, a keyboard 360, and a speaker(s) 370. The peripheral devices may communicate with the peripheral interface via a plurality of communication means, including both wired and wireless communication links. The plurality of peripheral devices may also include an external network interface 374 configured to facilitate communications over a network 380. The program ROM 310, RAM 320, microprocessor 330, and peripheral interface 340 communicate over a communication bus 390.

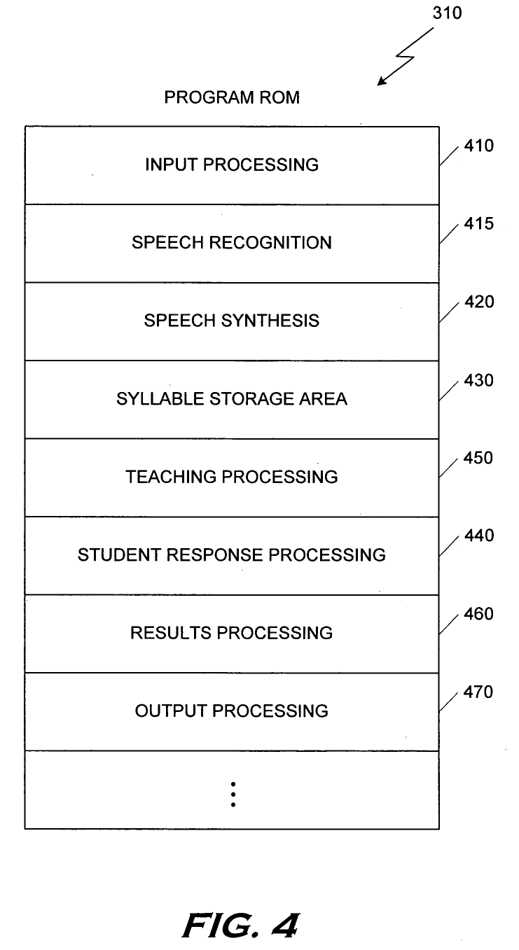

FIG. 4 is a block diagram of an exemplary program ROM 310 of the English teaching system 300, wherein the program ROM 310 comprises a plurality of processing modules. As can be appreciated by one of ordinary skill in the art, each of the modules comprises various sub-routines, procedures, definitional statements and macros. Each of the modules are typically separately compiled and linked into a single executable program. Therefore, the following description of each of the modules is used for convenience to describe the functionality of one embodiment of the system. Thus, the processes that are undergone by each of the modules may be arbitrarily redistributed to one of the other modules, combined together in a single module, or made available in, for example, a shareable dynamic link library.

The program ROM 310 comprises an input processing module 410 configured to process input data from the peripheral devices via the peripheral interface 340. The input processing module 410 may be further configured to convert audio or analog data received from a peripheral device to digital data. The program ROM 310 further comprises a speech recognition module 415 configured to receive the digital data corresponding to audio data received at the microphone 358. The speech recognition module 415 is further configured to determine speech components representing the audio data, wherein the speech components comprise letters, syllables, and words of the English language. Also included at the program ROM 310 is a speech synthesis module configured to convert digital data to audio data and transmit the audio data to the peripheral interface 340. The audio data transmitted to the peripheral interface 340 may be outputted to the user at the speakers 370, for example.

The program ROM 310 further comprises a syllable storage area 430 configured to store a defined set of syllables representing the English language, such as the syllables listed above. Also included at the program ROM 310 is a student response processing module 440 configured to assess a student's learning based on responses entered by the student at one or more of the peripheral devices 354, 358, 360. In addition to the student response processing module 440, the program ROM 310 also comprises a teaching processing module 450 configured to determine the syllables to teach a student based on the assessment of the student's learning performed by the student response processing module 440, for example. The program ROM 310 further comprises a results processing module configured to evaluate the student's performance, for example, based on input received at the microphone 358, keyboard 360, and/or joystick 354.

The microprocessor 330 is configured to execute the input processing module 410, the speech recognition module 415, the speech synthesis module 420, the teaching processing module 450, the student response processing module 440, the results processing module 460, and the output processing module 470 in accordance with the accelerated process 100 and training process 200 of FIGS. 1 and 2, for example.

While the above detailed description has shown, described, and pointed out novel features of the invention as applied to various embodiments, it will be understood that various omissions, substitutions, and changes in the form and details of the device or process illustrated may be made by those skilled in the art without departing from the intent of the invention.

What is claimed is:

1. A computerized system for teaching the English language using a predefined set of syllables, the system comprising:
a peripheral interface for receiving input data entered by a user on one or more peripheral devices and transmitting output data to a user on the one or more peripheral devices, the peripheral devices including a microphone;
a program nonvolatile memory for storing:
an input processing module for receiving and processing input data from the peripheral interface and converting audio data to digital data,
a speech recognition module for receiving the digital data corresponding to audio data received by the microphone and determining speech components representing the audio data, wherein the speech components comprise letters, syllables and words of the English language,
a syllable storage area for storing a defined set of syllables representing the English language,
a student response processing module for assessing the student's learning based on responses entered by the student,
a teaching processing module for determining the syllables to teach the student based on the assessment of the student's learning,
a results processing module for evaluating the student's performance, and
a speech synthesis module for converting digital data to audio data and transmitting the audio data to the peripheral interface; and
a processor for executing the input processing module, the speech synthesis module, the teaching processing module, the student response processing module, the results processing module, and the output processing module.

2. The system of claim 1, wherein the defined set of syllables representing the English language comprises 230 syllables.

3. The system of claim 2, wherein at least one of the syllables is accompanied by at least three example words illustrating that the same syllable can be found at the beginning of a first word, in substantially the middle of a second word, and at the end of a third word.

4. The system of claim 1, wherein the peripheral devices further comprise an external network connection for communicating with a remote system via a network so that student responses and results are monitored on the remote systems.

5. The system of claim 1, wherein the peripheral devices further comprise at least one speaker for playing audio data generated by the output processing module to the user.

6. A computerized method of teaching the English language, the method utilizing a defined set of syllables representing the English language, the method comprising:
vocalizing each letter of the English alphabet to a student;
instructing the student to write each letter of the English alphabet so that the student learns to correctly write each letter;
teaching a defined set of syllables to the student so that the student learns to correctly read and write each syllable;
vocalizing the defined set of syllables to the student and instructing the student to write the syllables so that the student learns to correctly write each syllable;
instructing the student to read and write words of the English language utilizing the student's knowledge of the syllables; and
instructing the student of exceptions in the English language for which the words are spelled differently than their syllabic sound.

7. The method of claim 6, wherein the defined set of syllables representing the English language comprises 230 syllables.

8. The method of claim 7, wherein the set of syllables comprises:
a b c d e f g h i j k l m n o p q r s t u v w x y z ea ee eo oo an en in on un ba be bi bo bu ar er ir or ur tha the thi tho thu da de di do du na ne ni no nu ma me mi mo mu la le li lo lu pa pe pi po pu gla gle gli glo glu fla fle fli flo flu cra cre cri cro cru bra bre bri bro bru pra pre pri pro pru gra gre gri gro gru ha he hi ho hu wra wre wri wro wru kna kne kni kno knu qua que qui quo va ve vi vo za ze zi zo zu sa se si so su phra phre phro cial sion sure ax ex ix ox ux xa xe xi ca ce ci co cu ka ke ki ko ku ga ge gi go gu ja je ji jo ju fa fe fi fo fu pha phe phi pho phy bla ble bli blo blu cla cle cli clo clu pla ple pli plo plu ra re ri ro ru dra dre dri dro dru fra fre fri fro fru tra tre tri tro tru thra thre thri thro thru sha she shi sho shu wha whe whi who ta te ti to tu wa we wi wo wu ya ye yi yo yu tude tion tive ture tial cha che chi cho chem chlo chu chri chro.

9. A computerized method of teaching the English language using a predefined set of syllables, the method comprising:
presenting a defined set of syllables to a student so that the student learns to correctly read and write each syllable; and
vocalizing and displaying the defined set of syllables to the student, wherein each syllable has a unique sound and spelling.

10. The method of claim 9, further comprising instructing the student to write the syllables so that the student learns to correctly write each syllable.

11. The method of claim 9, further comprising instructing the student to read and write words of the English language utilizing the student's knowledge of the syllables.

12. The method of claim 9, further comprising instructing the student of exceptions in the English language for which the words are spelled differently than their syllabic sound.

13. The method of claim 9, wherein teaching the defined set of syllables comprises heuristically presenting to the student a plurality of exemplary words for each of the syllables.

14. The method of claim 13, wherein at least one of the exemplary words is associated with the syllable being taught at the beginning of the word.

15. The method of claim 13, wherein at least one of the exemplary words is associated with the syllable being taught in the middle of the word.

16. The method of claim 13, wherein at least one of the exemplary words is associated with the syllable being taught at the end of the word.
